(19) United States
(12) Patent Application Publication
(10) Pub. No.: US 2011/0032156 A1
(43) Pub. Date: Feb. 10, 2011

(54) ANTENNA APPARATUS

(76) Inventors: Ren Sugiyama, Tokyo (JP); Yasuo Kokubun, Tokyo (JP)

Correspondence Address: HOLTZ, HOLTZ, GOODMAN & CHICK PC, 220 Fifth Avenue, 16TH Floor, NEW YORK, NY, 10001-7708, US

(21) Appl. No.: 12/936,988

(22) PCT Filed: Apr. 7, 2009
(86) PCT No.: PCT/JP2009/057116

§ 371 Date: Oct. 8, 2010

(30) Foreign Application Priority Data
Apr. 8, 2008 (JP) 2008-100063

(51) Int. Cl. H01Q 1/38

(52) U.S. Cl. 343/700 MS

(57) ABSTRACT

An antenna apparatus includes an antenna element, a feeder connected to the antenna element, a matching circuit connected to the feeder, a feeding point connected to the matching circuit, and a ground plate, on which the feeding point and the matching circuit are mounted. The antenna element includes a first plate section extending in parallel with the extending direction of the ground plate, a second plate section extending from the apical end of the first plate section almost perpendicularly, and a third plate section extending from the apical end of the second plate section in parallel with the first plate section. The ground plate can freely be folded up to the extending direction thereof. Interval G, length L, and ratio R satisfy the relations of formulae (1)-(3):

G=R×L (1),

3.5 mm≦L≦11 mm (2), and

0.06≦R≦0.95 (3).

### TECHNICAL FIELD

The present invention relates to an antenna apparatus, and more particularly to a one-segment broadcasting receiving antenna apparatus to be mounted in a cellular phone handset.

### BACKGROUND ART

Because the miniaturization of a communication antenna for a telephone conversation use has advanced, a cellular phone handset can exhibit a sufficient telephone conversation performance even with the antenna housed in the housing of the cellular phone handset. Consequently, it has become possible to use a design having a high degree of freedom without being hindered by the communication antenna for the appearance configuration of the cellular phone handset.

Meanwhile, a cellular phone handset which can receive one-segment broadcasting has also been put to practical use in recent years. However, the real situation is that, even if it is tried to receive one-segment broadcasting with the aforesaid communication antenna, the communication antenna built in the cellular phone handset cannot receive the one-segment broadcasting because the length of one wavelength of a one-segment broadcasting wave is within a range of from 43 cm to 64 cm.

Accordingly, an antenna apparatus receiving one-segment broadcasting by mounting a rod antenna corresponding to the length of the wavelength of a one-segment broadcasting wave in a cellular phone handset separately from a communication antenna was developed (see, for example, Patent Document 1).

### PRIOR ART DOCUMENTS

### Patent Documents

Patent Document 1: Japanese Patent Application Laid-Open Publication No. 2007-281832

### SUMMARY OF THE INVENTION

### Problems to be Solved by the Invention

In case of a rod antenna, however, it is difficult to receive one-segment broadcasting with the rod antenna remaining built in the housing of the cellular phone handset, and it is necessary to expose the rod antenna to the outside of the housing by attaching or extending the rod antenna at the time of a use thereof. In particular, in the antenna apparatus described in Patent Document 1, the rod antenna is made to be removable from the housing owing to the problem of its housing space, but the rod antenna must be removed from the housing at the time of being unused and must be attached to the housing at the time of being used. Consequently, the antenna apparatus has a problem of being impossible for a user to watch one-segment broadcasting everywhere without carrying the rod antenna together with the cellular phone handset.

Furthermore, even in the case of using a telescopic rod antenna, a user must extend the rod antenna at the time of a use, and the extension operation has given the user troublesomeness.

It is an object of the present invention to provide an antenna apparatus capable of receiving one-segment broadcasting with the antenna apparatus remaining built in the housing of a cellular phone handset to reduce the troublesomeness at the time of receiving one-segment broadcasting with the degree of freedom of the appearance designing of the cellular phone handset raised.

### Means for Solving the Problems

The invention recited in claim 1 is an antenna apparatus including:

an antenna element;

a feeder connected to the antenna element;

a matching circuit connected to the feeder;

a feeding point connected to the matching circuit; and

a ground plate, on which the feeding point and the matching circuit are mounted, wherein

the antenna element includes:

a first plate section connected to the feeder, the first plate section extending into a direction of going away from the ground plate in parallel with an extending direction of the ground plate;

a second plate section extending from an apical end of the first plate section almost perpendicularly; and

a third plate section extending from an apical end of the second plate section into a direction of coming closer to the ground plate in parallel with the first plate section;

the ground plate can freely be folded up to the extending direction thereof; and

when an interval of a gap from the ground plate to the antenna element, the interval formed by the feeder, is denoted by G, a length from the ground plate to an outer end portion of the second plate section is denoted by L, and a ratio of the interval G to the length L is denoted by R, the interval G, the length L, and the ratio R satisfy formulae (1)-(3),

G=R·L (1),

3.5 mm≦L≦11 mm (2), and

0.06≦R≦0.95 (3).

The invention recited in claim 2 is he antenna apparatus according to claim 1, wherein

when the ratio R is obtained in accordance with a formula (4), coefficients a1-a5 of the formula (4) satisfy following ranges, respectively,

R=a₁·L⁴+a₂·L³+a₃·L²+a₄·L+a₅ (4)

−0.0064≦a₁≦0.002204,

−0.07982≦a₂≦0.2316,

−3.1078≦a₃≦1.07710,

−6.4392≦a₄≦18.4168, and

−40.3927≦a₅≦14.5431.

The invention recited in claim 3 is the antenna apparatus according to claim 2, wherein

the coefficients a1-a5 of the formula (4) satisfy following ranges, respectively, and the length L and the ratio R satisfy relations of formulae (5) and (6), respectively,

−0.0064≦a₁≦0.001554,

−0.05592≦a₂≦0.2316,

−3.1078≦a₃≦0.75217,

−4.5048≦a₄≦18.4168,

−40.3927≦a₅≦10.3087,

6.6 mm≦L≦11mm (5), and

0.08≦R≦0.61 (6).

The invention recited in claim 4 is the antenna apparatus according to any one of claims 1-3, wherein

an extending length of the first plate section and an extending length of the third plate section are almost same.

The invention recited in claim 5 is the antenna apparatus according to any one of claims 1-4, wherein

a width of the antenna element is set to be almost same as that of the ground plate.

The invention recited in claim 6 is the antenna apparatus according to any one of claims 1-4, wherein

the ground plate is composed of two substrates in a state of being freely folded up, each being sized to have an extending length of 73 to 82 mm and a width of 35 to 45 mm.

### EFFECTS OF THE INVENTION

The inventors of the present invention found that the antenna apparatus could receive a one-segment broadcasting wave even with the antenna apparatus remaining built in the housing of a cellular phone handset if the antenna element was used together with the matching circuit, the antenna element being composed of the first plate section extending toward the direction of going away from the ground plate in parallel with the extending direction of the ground plate, the second plate section extending from the apical end of the first plate section almost perpendicularly, and the third plate section extending from the apical end of the second plate section toward the direction of coming closer to the ground plate in parallel with the first plate section, and further if the interval G, the length L, and the ratio R were set to satisfy the formulae (1)-(3). That is, if the antenna apparatus of the present invention is applied to a cellular phone handset, one-segment broadcasting can be received with the antenna apparatus remaining built in the housing of the cellular phone handset, and, as a result, the troublesomeness at the time of receiving the one-segment broadcasting can be reduced with the degree of freedom of the appearance designing of the cellular phone handset raised.

### BRIEF DESCRIPTION OF DRAWINGS

FIG. 1 is a top view showing the schematic configuration of an antenna apparatus according to an embodiment;

FIG. 2 is a side view showing the schematic configuration of the antenna apparatus of FIG. 1;

FIG. 3A is a top view showing the schematic configuration of an antenna element provided in the antenna apparatus of FIG. 1;

FIG. 3B is a side view showing the schematic configuration of the antenna element provided in the antenna apparatus of FIG. 1;

FIG. 3C is a bottom view showing the schematic configuration of the antenna element provided in the antenna apparatus of FIG. 1;

FIG. 4 is a circuit diagram showing the circuit configuration of a matching circuit provided in the antenna apparatus of FIG. 1;

FIG. 5 is a top view showing the schematic configuration of an antenna apparatus in which no matching circuit is mounted;

FIG. 6 is a graph showing an antenna characteristic of the antenna apparatus of FIG. 5;

FIG. 7 is a graph showing radiation efficiency in case of a length L=7 mm;

FIG. 8 is a graph showing radiation efficiency in case of a length L=9 mm;

FIG. 9 is a graph showing radiation efficiency in case of a length L=11 mm;

FIG. 10 is a graph showing the minimum radiation efficiency values to the respective gap ratios R in a one-segment frequency band at each length L;

FIG. 11 is a graph in which the minimum values and the maximum values of the gap ratios R being −8.0 dB or more are plotted at each length L;

FIG. 12 is a graph showing how the minimum radiation efficiency values vary in the one-segment frequency band in accordance with the variations of the extending length L2 of a substrate with the gap ratio R fixed to 0.2 at each length L;

FIG. 13A is an explanatory drawing showing one modification of a third plate section in the antenna element of FIGS. 3A-3C;

FIG. 13B is an explanatory drawing showing another modification of the third plate section in the antenna element of FIGS. 3A-3C;

FIG. 13C is an explanatory drawing showing a modification of a first plate section in the antenna element of FIGS. 3A-3C;

FIG. 14A is an explanatory drawing showing an antenna element, having a third plate section the extending length of which is longer than that of a first plate section, being modified from the antenna element of FIGS. 3A-3C;

FIG. 14B is an explanatory drawing showing an antenna element, having a first plate section the extending length of which is longer than that of a third plate section, being modified from the antenna element of FIGS. 3A-3C; and

FIG. 15 is a graph in which the minimum values and the maximum values of the gap ratios R being −8.0 dB or more at each length L are plotted by approximate curves to each thickness T.

### BEST MODE FOR CARRYING OUT THE INVENTION

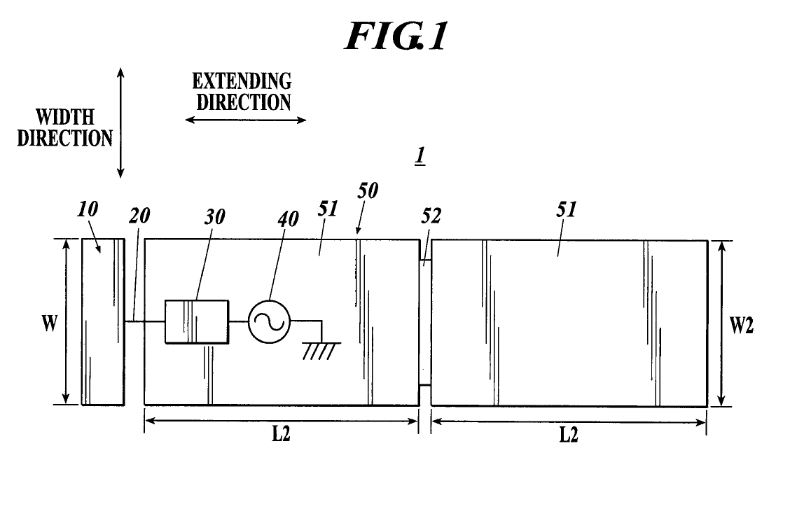

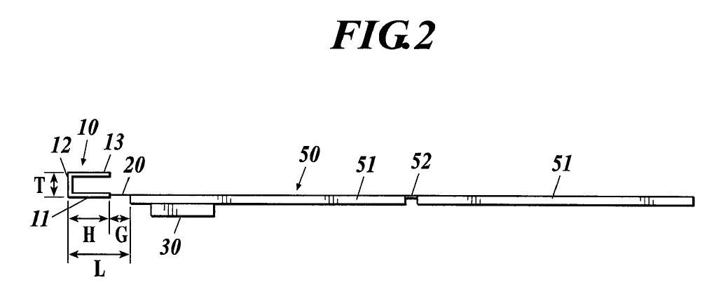

In the following, an antenna apparatus according to an embodiment will be described with reference to the accompanying drawings. FIG. 1 is a top view showing the schematic configuration of the antenna apparatus of the present embodiment, and FIG. 2 is a side view thereof. As shown in FIGS. 1 and 2, the antenna apparatus 1 is provided with an antenna element 10, a feeder 20 connected to the antenna element 10, a matching circuit 30 connected to the feeder 20, a feeding point 40 connected to the matching circuit 30, and a ground plate 50 mounting the feeding point 40 and the matching circuit 30 thereon.

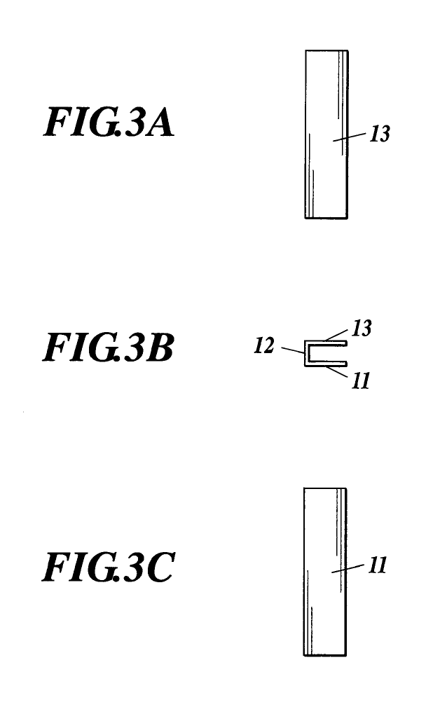

FIG. 3A is a top view showing the schematic configuration of the antenna element 10; FIG. 3B is a side view thereof; and FIG. 3C is a bottom view thereof. As shown in FIG. 1 and FIGS. 3A-3C, the antenna element 10 is provided with a first plate section 11 extending toward the direction of going away from the ground plate 50 in parallel with the extending direction of the ground plate 50, a second plate section 12 extending from the apical end of the first plate section 11 almost perpendicularly, and a third plate section 13 extending from the apical end of the second plate section 12 toward the direction of coming closer to the ground plate 50 in parallel with the first plate section 11. Then, the extending length of the first plate section 11 and the extending length of the third plate section 13 are set to be almost the same. Thereby, the antenna element 10 is formed in almost a U shape (inverted U shape in FIG. 3B) with a flat bottom when viewed from the side.

Because the antenna element 10 is to be built in a portable device, such as a cellular phone handset, the sizes of the antenna element 10 are preferably designed in the following ranges: a width W=35 to 50 mm, a thickness T=1.5 to 7 mm, and a length H=5 to 10 mm. In addition, the width W of the antenna element 10 is preferably set to be within the aforesaid range and almost equal to the width W2 of the ground plate 50.

The antenna element 10 is formed by bending a metal plate having a plate thickness of, for example, about 0.15 mm. As the metal plate, for example, a sheet metal, copper foil, a flexible substrate, and the like, can be given. If the strength of the metal plate is large, the space between the first plate section 11 and the second plate section 12 can be made to be hollow by the single body of the antenna element 10 in order to keep the parallel state of the first plate section 11 and the second plate section 12. If the single body of the antenna element 10 has not the strength sufficient for keeping the parallel state, however, the parallel state of the first plate section 11 and the third plate section 13 is kept by making a spacer made of, for example, a dielectric, such as a resin, intervene between the first plate section 11 and the third plate section 13. In addition, if the spacer is made of a resin, the resin has a certain dielectric constant. It is also possible, accordingly, to miniaturize the antenna element 10 owing to the wavelength shortening effect of an electric wave by the dielectric constant. In addition, it is preferable to miniaturize the antenna element 10 within the ranges without departing from the aforesaid sizes at the time of miniaturizing the antenna element 10.

The feeder 20 is formed of a material that is ordinarily used for conductor wiring, such as a lead wire, copper foil, and a flexible substrate. As shown in FIGS. 1 and 2, the apical end portion of the feeder 20 is connected to the base end portion of the first plate section 11 of the antenna element 10. To put it concretely, the apical end portion of the feeder 20 is connected to almost the center of the first plate section 11 in the width direction thereof. On the other hand, the base end portion of the feeder 20 is connected to the matching circuit 30 on the ground plate 50.

The interval G, which is the gap from the ground plate 50 to the antenna element 10, is formed by the feeder 20, and is set to a value at which the relations of the interval G to a length L (=H+G) from the ground plate 50 to an outer end portion of the second plate section 12 and the ratio R of the interval G to the length L satisfy at least the following formulae (1)-(3).

G=R·L (1)

3.5 mm≦L≦11 mm (2)

0.06≦R≦0.95 (3)

Furthermore, a value preferable as the interval G is one falling into a range satisfying the following formulae (5) and (6).

6.6 mm≦L≦11 mm (5)

0.08≦R≦0.61 (6)

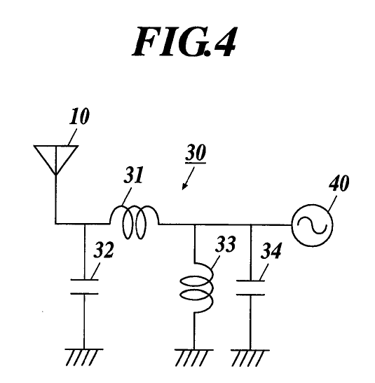

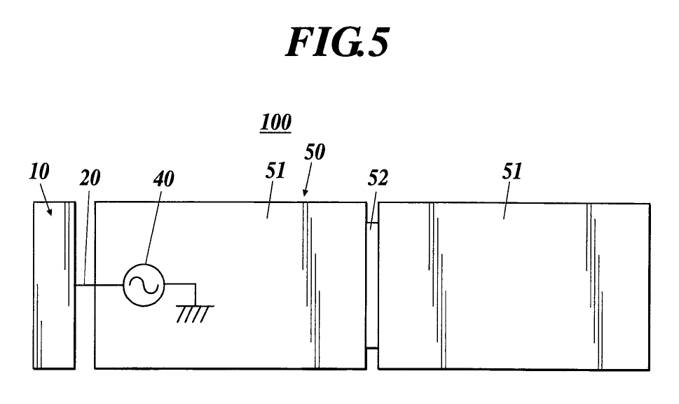

The matching circuit 30 adjusts the center frequency of the antenna element 10 into the frequency band of one-segment broadcasting. The circuit configuration of the matching circuit 30 may be any circuit configuration as long as it can adjust the center frequency of the antenna element 10 into the frequency band of the one-segment broadcasting, as described above. The present embodiment, for example, uses the matching circuit 30 of the circuit configuration shown in FIG. 4. To put it concretely, the matching circuit 30 is, as shown in FIG. 4, provided with a first inductor 31, connected in series with the antenna element 10 and the feeding point 40; a first capacitor 32, connected to the first inductor 31 on the antenna element 10 side thereof so as to be in parallel with the antenna element 10; a second inductor 33, connected to the first inductor 31 on the feeding point 40 side thereof to be in parallel with the antenna element 10; and a second capacitor 34, connected to the first inductor 31 on the feeding point 40 side thereof so as to be in parallel with the antenna element 10. The other ends of the first capacitor 32, the second inductor 33, and the second capacitor 34 are connected to the ground.

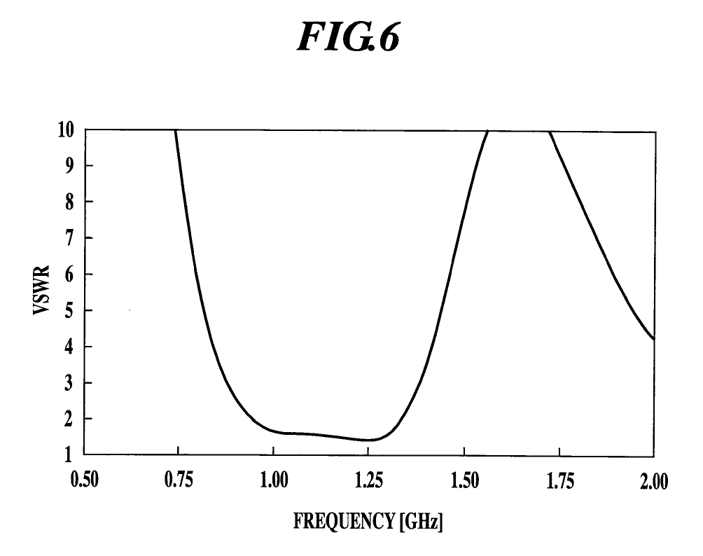

Now, in case of an antenna apparatus 100, in which the matching circuit 30 is not mounted as shown in FIG. 5, the antenna apparatus 100 cannot receive any electric waves in the frequency band (470 MHz to 770 MHz) of one-segment broadcasting because the center frequency of the antenna apparatus 100 is about 1.1 GHz, and the bandwidth in which the voltage standing wave ratio (VSR) of a received wave is 3 or less is about 450 MHz (see FIG. 6), even if the other configurations are the same as those of the aforesaid antenna apparatus 1. If the matching circuit 30 is mounted as shown in FIG. 1, however, it becomes possible to shift the center frequency into the frequency band of one-segment broadcasting.

If the inductance of the first inductor 31 is set within a range of from 15 nH to 27 nH here, it is possible to shift the center frequency into the frequency band of one-segment broadcasting. In addition, because the constants of the matching adjustment of the other first capacitor 32, the second inductor 33, and the second capacitor 34 vary owing to the sizes of the ground plate 50 and the like, it is necessary to set the inductance to be fitted to the sizes.

As shown in FIG. 1, the ground plate 50 is composed of two almost quadrilateral plate-like substrates 51 to be capable of being freely folded up in their extending directions. To put it concretely, the two substrates 51 are coupled to each other at the folded-up position with a flexible substrate 52 or the like. Then, the circuit elements of a cellular phone handset are mounted on the ground plate 50 in addition to the feeder 20, the matching circuit 30, and the feeding point 40. In addition, because it is a premise that the ground plate 50 is mounted in the cellular phone handset, the sizes of each of the substrates 51 fall in the ranges capable of being built in the cellular phone handset: to put it concretely, an extending length L2 within a range of 73 to 82 mm and the width W2 within a range of 35 to 45 mm.

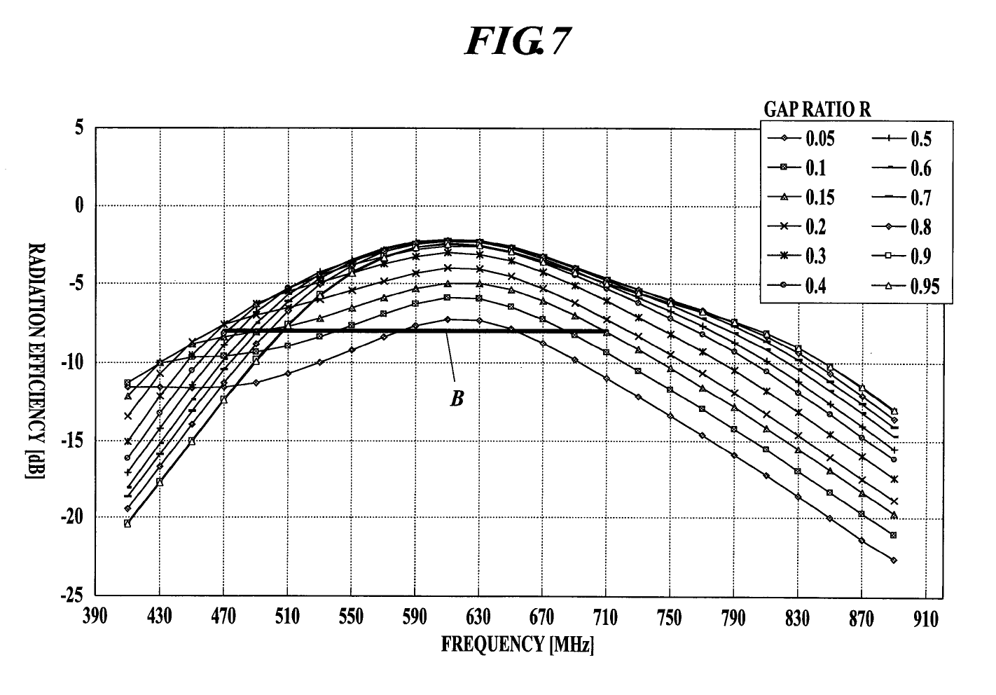

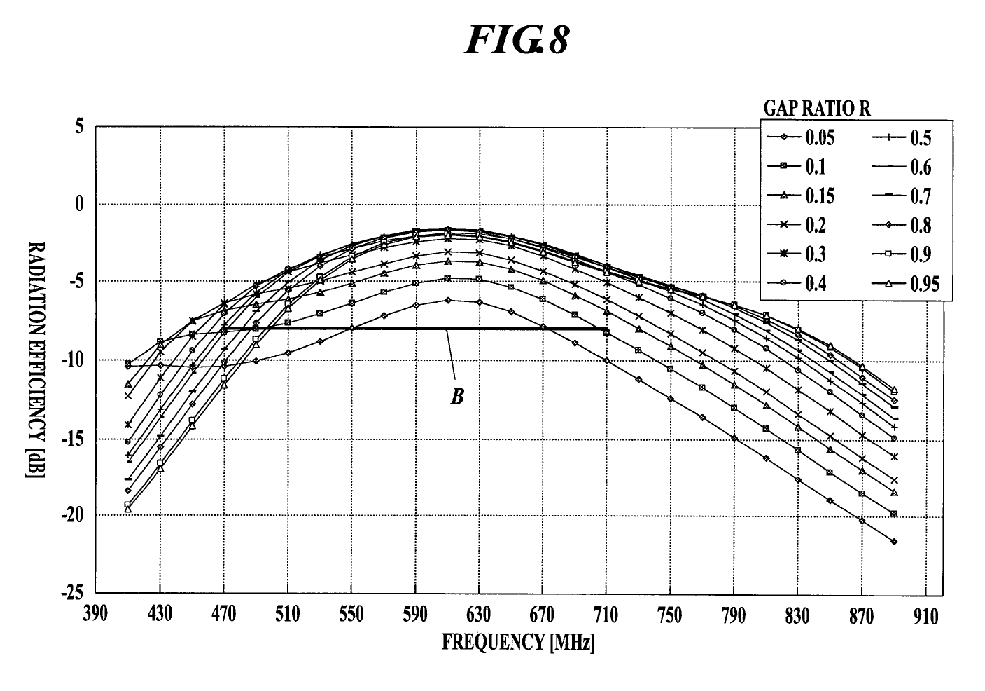

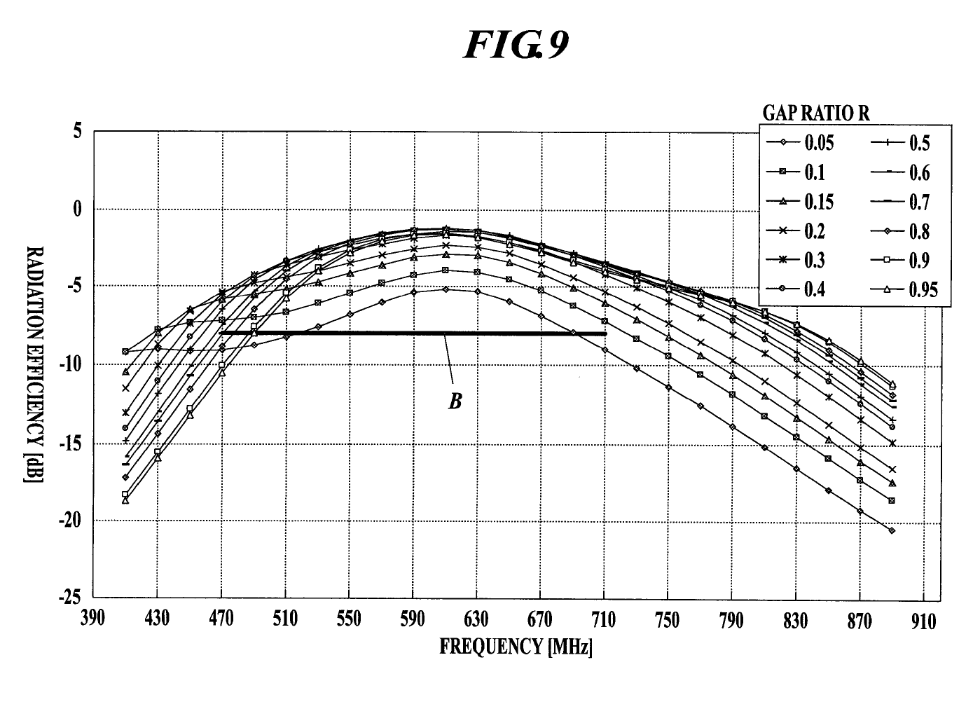

Next, how the radiation efficiency of the antenna apparatus 1 varies dependingly on the difference of the gap ratio R (=G/L) of the interval G to the length L is described. FIG. 7 is a graph showing the results of the obtainment of the radiation characteristics of the respective gap ratios R by simulations under the conditions of fixing the length L to 7 mm and varying the length H of the antenna element 10 and the interval G. Furthermore, FIG. 8 is a graph showing the results of the obtainment of the radiation characteristics of the respective gap ratios R by simulations under the conditions of fixing the length L to 9 mm and varying the length H of the antenna element 10 and the interval G. FIG. 9 is a graph showing the results of the obtainment of the radiation characteristics of the respective gap ratios R by simulations under the conditions of fixing the length L to 11 mm and varying the length H of the antenna element 10 and the interval G. In addition, the other sizes of the antenna element 10 were made as follows: the width W=40 mm and the thickness T=2 mm. Furthermore, the substrates 51 was sized to have the width W2=40 mm and the length L2=80 mm. Furthermore, the inductance of the first inductor 31 of the matching circuit 30 was made to be 22 nH.

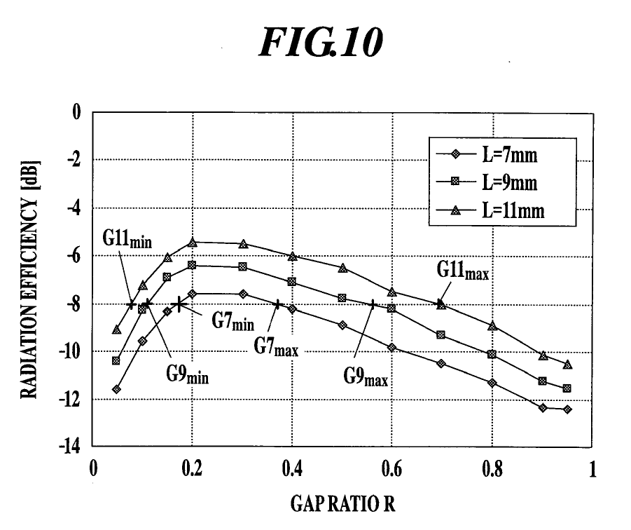

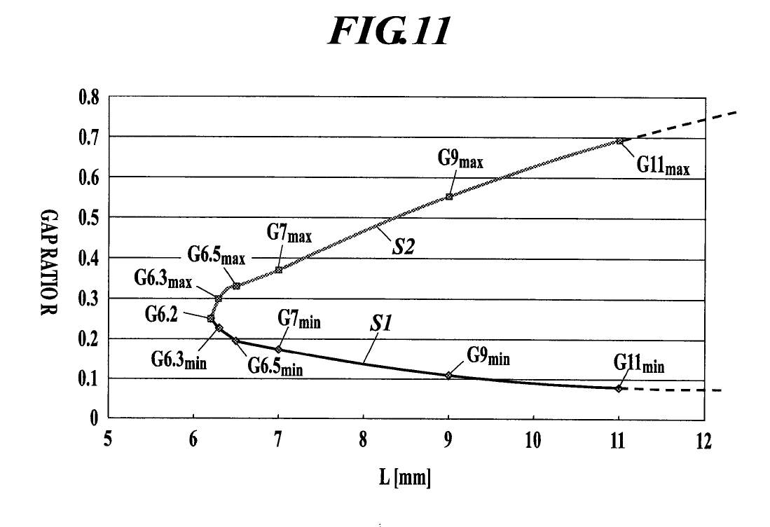

If the radiation efficiency in a 470 MHz-710 MHz band is −8.0 dB or more here, the reception function of one-segment broadcasting is led to be satisfied (see thick lines B in FIGS. 7, 8, and 9). FIG. 10 is a graph showing the minimum radiation efficiency values to the respective gap ratios R in the one-segment frequency band to each of the lengths L on the basis of the aforesaid results. In case of the length L=7 mm, the radiation efficiency becomes −8.0 dB or more when the gap ratio R falls into a range of from 0.1731 or more to 0.37073 or less (see G7ₘᵢₙ and G7ₘₐₓ in FIG. 10). In case of the length L=9 mm, the radiation efficiency becomes −8.0 dB or more when the gap ratio R falls into a range of from 0.10922 or more to 0.55317 or less (see G9ₘᵢₙ and G9ₘₐₓ in FIG. 10). In case of the length L=11 mm, the radiation efficiency becomes −8.0 dB or more when the gap ratio R falls into a range of from 0.1731 or more to 0.37073 or less (see G11ₘᵢₙ and G11ₘₐₓ in FIG. 10). That is, if the gap ratio R falls in a range of from 0.1731 or more to 0.37073 or less, the radiation efficiency is led to exceed −8.0 dB in the whole one-segment frequency band to any of the lengths L.

Then, the minimum values (G7ₘᵢₙ, G9ₘᵢₙ, and G11ₘᵢₙ) and the maximum values (G7ₘₐₓ, G9ₘₐₓ, and G11ₘₐₓ) of the gap ratios R that made the radiation efficiency −8.0 dB or more were plotted to each of the lengths L, and furthermore the minimum values (G6.3ₘᵢₙ and G6.5ₘᵢₙ) and the maximum values (G6.3ₘₐₓ and G6.5ₘₐₓ) at lengths L=6.2 mm, 6.3 mm, and 6.5 mm were newly added (see FIG. 11). In addition, the maximum value and the minimum value at the length L=6.2 mm were almost the same values (G6.2). Approximate curves were obtained from these results. An approximate curve S1 of the minimum values was expressed by formulae (7) and (8), and an approximate curve S2 of the maximum values was expressed by formulae (9) and (10).

The approximate curve S1 is

Rₘᵢₙ=−1.0538·L²+13.651·L−43.877 (7)

in case of 6.2≦L≦6.5,or

Rₘᵢₙ=−2.0789×10⁻³·L³+5.0840×10⁻²·L²−3.2099×10⁻¹·L+8.3955×10 ⁻¹ (8)

in case of 6.5<L.

The approximate curve S2 is

Rₘₐₓ=2.101×10⁻¹·L²−2.854·L+9.8665 (9)

in case of 6.2≦L≦6.5, or

Rₘₐₓ=−3.6556×10⁻⁵·L³+5.1745×10⁻³·L²−1.0768×10⁻¹·L+6.8583×10⁻¹ (10)

in case of 6.5<L.

That is, if the gap ratio R falls into the inside region (formula (11)) formed by these two approximate curves S1 and S2, the radiation efficiency exceeds −8.0 dB in at least a part of the one-segment frequency band.

Rₘᵢₙ≦R≦Rₘₐₓ (11)

In addition, if the length L is smaller than the intersection point (G6.2) of the aforesaid two approximate curves S1 and S2, the gap ratio R does not satisfies the relation of the formula (11), and consequently the length L is required to be at least 6.2 mm or more.

Then, when a local minimal value of the approximate curve S1 was obtained, the gap ratio was R˜0.076. When a local maximal value of the approximate curve S2 was obtained, the gap ratio was R˜0.860.

0.0075·L≦G0.86·L (12)

If the interval G falls into at least the range of the formula (12), the radiation efficiency is led to exceed −8.0 dB in at least a part of the one-segment frequency band, and it becomes possible to receive the one-segment broadcasting wave suitably in that part. In particular, if the length L is 11 mm, the radiation efficiency is led to exceed −8.0 dB in almost the whole region of the one-segment frequency band as long as the interval G falls in the range of the formula (12). On the other hand, even if the length L is 7 mm, the radiation efficiency is led to exceed −8.0 dB in almost the half region of the one-segment frequency band as long as the interval G falls in the range of the formula (12).

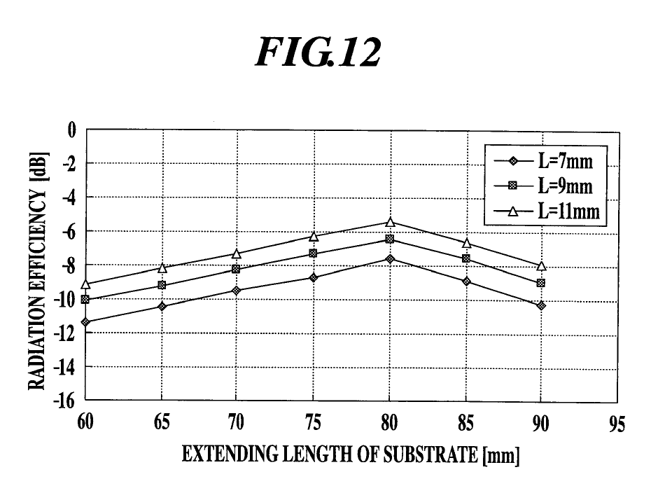

Next, in case of the substrates 51 satisfying the aforesaid conditions, the antenna characteristic becomes the best when the gap ratio R is 0.2. How the minimum radiation efficiency values vary in the one-segment frequency band on the basis of the variations of the extending length L2 of each of the substrates 51 was compared in each of the lengths L with the gap ratio R fixed to 0.2 here. The comparison results are expressed as a graph in FIG. 12. As it can be known from FIG. 12, the radiation efficiency takes a peak value at the extending length L2 of each of the substrates 51 of 80 mm and gradually falls as the extending length L2 becomes distant from 80 mm in any of the lengths L. Consequently, the length preferable as each of the extending lengths L2 of the substrates 51 is one within a range of 78-82 mm, in which the radiation efficiency exceeds −8.0 dB, and a more preferable length is 80 mm.

Furthermore, although FIG. 11 showed the approximate curves S1 and S2 in the case where the thickness T of the antenna element 10 was made to be constant to be 2 mm, the thickness T of the antenna element 10 was changed to be 1.5 mm, 2 mm, 3 mm, 4.25 mm, 5.5 mm, and 7 mm, and the approximate curves of each of the thicknesses T were plotted by the similar method as that described above to obtain FIG. 15. As apparent from also FIG. 15, if the gap ratio R falls into the range of the formula (3), the radiation efficiency is led to exceed −8.0 dB in at least a part of the one-segment frequency band, and it becomes possible to receive the one-segment broadcasting wave suitably in that part.

Next, the approximate curves S1 and S2 at each of the thicknesses T will be described.

The approximate curve S1(1.5) of the minimum values and the approximate curve S2(1.5) of the maximum values at the thickness T=1.5 mm are expressed by the formulae (13) and (14), respectively.

Rₘᵢₙ=0.002204·L⁴+0.079818·L³+1.0771·L²−6.4392·L−14.5430 (13)

Rₘₐₓ=−0.0064·L⁴+0.2316·L³−3.1078·L²+18.4168·L−40.3927 (14)

The approximate curve S1(2.0) of the minimum values and the approximate curve S2(2.0) of the maximum values at the thickness T=2 mm are expressed by the formulae (15) and (16), respectively.

Rₘᵢₙ=0.001553·L⁴−0.05592·L³+0.7522·L²−4.5048·L+10.12089 (15)

Rₘₐₓ=0·L⁴+0.002717·L³−0.07379·L²+0.7403·L−2.1408 (16)

The approximate curve S1(3.0) of the minimum values and the approximate curve S2(3.0) of the maximum values at the thickness T=3 mm are expressed by the formulae (17) and (18), respectively.

Rₘᵢₙ=0.001650·L⁴31 0.05862·L³+0.7760·L²−4.55061·L+10.12089 (17)

Rₘₐₓ=−0.001637·L⁴+0.05613·L³−0.7151·L²+4.0855·L−8.3085 (18)

The approximate curve S1(4.25) of the minimum values and the approximate curve S2(4.25) of the maximum values at the thickness T=4.25 mm are expressed by the formulae (19) and (20), respectively.

Rₘᵢₙ=0.001711·L⁴−0.05666·L³+0.6929·L²−3.7267·L+7.5984 (19)

Rₘₐₓ=−0.001700·L⁴+0.05469·L³−0.6508·L²+3.4476·L−6.1410 (20)

The approximate curve S1(5.5) of the minimum values and the approximate curve S2(5.5) of the maximum values at the thickness T=5.5 mm are expressed by the formulae (21) and (22), respectively.

Rₘᵢₙ=0.0008661·L⁴−0.02814·L³+0.3377·L²−1.7902·L+3.6819 (21)

Rₘₐₓ=−0.0006322·L⁴+0.02132·L³−0.2696·L²+1.5280·L−2.3549 (22)

The approximate curve S1(7.0) of the minimum values and the approximate curve S2(7.0) of the maximum values at the thickness T=7 mm are expressed by the formulae (23) and (24), respectively.

Rₘᵢₙ=0.0002999·L⁴−0.01099·L³+0.1534·L²−0.9780·L+2.5035 (23)

Rₘₐₓ=−0.001601·L⁴+0.05213·L³−0.6225·L²+3.2261·L−5.1667 (24)

Any of these formulae (13)-(24) is shown as a quartic polynomial. The minimum coefficient of each term is selected among each of the coefficients of the respective approximate curves S1(1.5), S1(2.0), S1(3.0), S1(4.25), S1(5.5), and S1(7) of the minimum values here. Similarly, the maximum coefficient of each term is selected among each of the coefficients of the respective approximate curves S2(1.5), S2(2.0), S2(3.0), S2(4.25), S2(5.5), and S2(7) of the maximum values.

For example, if the gap ratio R is expressed by a formula (4), each of the coefficients a1-a5 is in the following ranges by the aforesaid selection. To put it concretely, the minimum coefficient of each term is the lower limit value of each of the following ranges, and the maximum coefficient of each term is the upper limit value of each of the following ranges.

R=a₁·L⁴+a₂·L³+a₃·L²+a₄·L+a₅ (4)

−0.0064≦a₁≦0.002204,

−0.07982≦a₂≦0.2316,

−3.1078≦a₃≦1.07710,

−6.4392≦a₄≦18.4168, and

−40.3927≦a₅≦14.5431.

If the formulae (1)-(3) are satisfied and further each of the coefficients a1-a5 of a gap ratio R satisfies the aforesaid ranges, it becomes possible to more accurately set the interval G by which the radiation efficiency is led to exceed −8.0 dB.

Furthermore, if the gap ratio R falls into an inside region (hatched part in FIG. 15) formed by the approximate curve S1(2.0) and the approximate curve S2(1.5) in FIG. 15, the radiation efficiency of any antenna element 10 having any thickness T is lead to exceed −8.0 dB. That is, if the interval G falling into the inside region can be set, the antenna element 10 having high radiation efficiency can be realized at any thickness T.

The conditions for falling into the inside region are that each of the coefficients a1-a5 in the formula (4) satisfies the following ranges, and that the length L and the gap ratio R satisfy the relations of formulae (5) and (6). In addition, the minimum coefficient of each term among each of the coefficients of the approximate curve S1(2.0) and the approximate curve S2(1.5) is the lower limit value of each of the following ranges, and the maximum coefficient of each term among each of the coefficients is the upper limit value of each of the following ranges. As long as the gap ratio R satisfies the conditions, it becomes possible to accurately set the interval G by which the radiation efficiency is led to exceed −8.0 dB even if the thickness T is any thickness.

−0.0064≦a₁≦0.001554,

−0.05592≦a₂≦0.2316,

−3.1078≦a₃≦0.75217,

−4.5048≦a₄≦18.4168,

−40.3927≦a₅≦10.3087,

6.6 mm≦L≦11mm (5), and

0.08≦R≦0.61 (6).

As described above, the embodiment described above uses the antenna element 10 and the matching circuit 30. The antenna element 10 includes the first plate section 11, extending into the direction of going away from the ground plate 50 in parallel with the extending direction of the ground plate 50; the second plate section 12, extending from the apical end of the first plate section 11 almost perpendicularly; and the third plate section 13, extending from the apical end of the second plate section 12 into the direction of coming closer to the ground plate 50 in parallel with the first plate section 11. Furthermore, in the embodiment, the interval G, the length L, and the gap ratio R satisfy the formulae (1)-(3). Consequently, even if the antenna apparatus 10 is of the size enabling the antenna element 10 to be housed in the housing of a cellular phone handset, the antenna apparatus 10 can receive an one-segment broadcasting wave. Thereby, because it becomes possible to always incorporate the antenna apparatus 10 in the housing of the cellular phone handset, it becomes possible to reduce the troublesomeness at the time of receiving one-segment broadcasting with the degree of freedom of the appearance designing of the cellular phone handset raised.

In addition, the present invention is not limited to the embodiment described above, but can suitably be changed. In the following descriptions, the same parts as those of the aforesaid embodiment will be denoted by the same marks as those of the embodiment, and the descriptions of the same parts will be omitted.

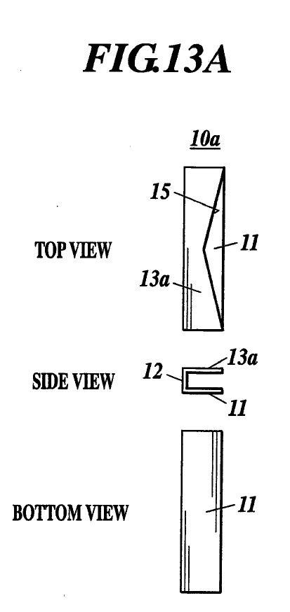

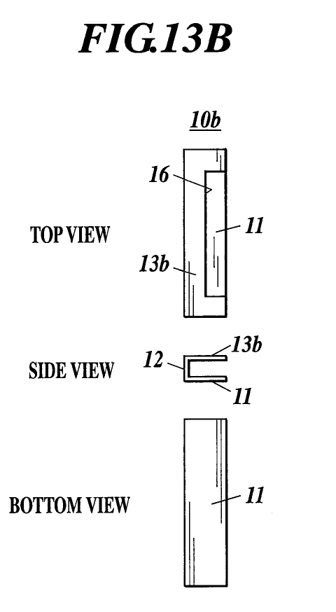

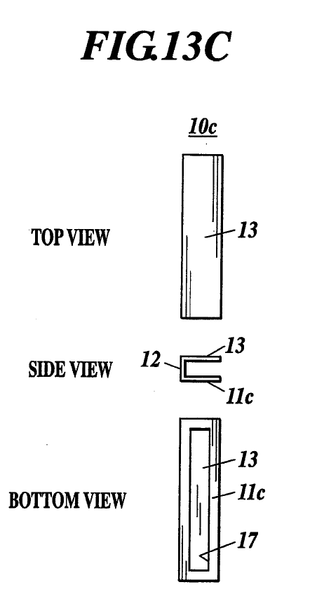

For example, although the present embodiment has described the case where the first plate section 11 and the third plate section 13 of the antenna element 10 have the same shapes by illustrating the case, both the first plate section 11 and the third plate section 13 need not take the same shapes. For example, as an antenna element 10a shown in FIG. 13A and an antenna element 10b shown in FIG. 13B, a triangular notch 15 and a quadrilateral notch 16 may be formed in third plate sections 13a and 13b on the ground plate 50 side, respectively. This is because the electric currents flowing through the parts of the third plate sections 13a and 13b on the ground plate 50 side are small and the omission of the parts does not exert influences so much onto the antenna characteristics.

On the other hand, in the antenna element 10c shown in FIG. 13C, an aperture 17 is formed in the first plate section 11c. This is because the first plate section 11c is directly connected to the feeder 20 and consequently all of the four sides thereof, which are current paths, must be covered unlike the third plate section 13.

Then, because it is also possible to pack parts in the spaces by forming the notches 15 and 16 and the aperture 17 as described above, it becomes possible to achieve miniaturization and weight saving.

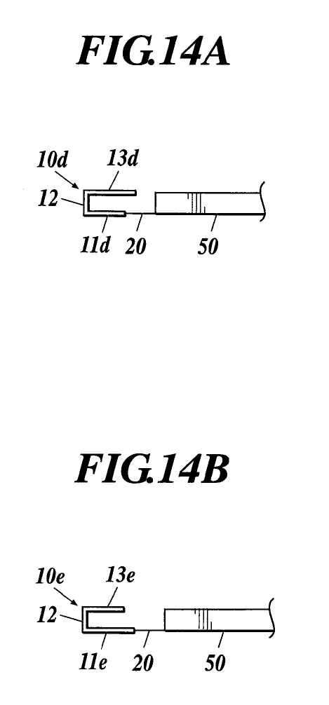

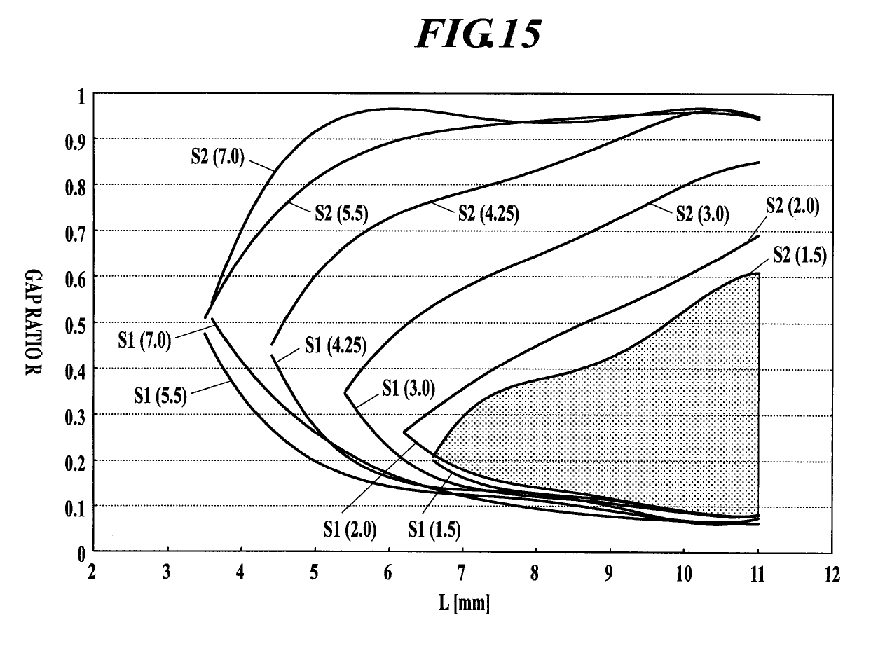

Furthermore, although the present embodiment has described the case where the first plate section 11 and the third plate section 13 have almost the same extending lengths by illustrating the case, the extending length of a third plate section 11d may be longer than that of a first plate section 11d as an antenna element 10d shown in FIG. 14A, or contrarily the extending length of a first plate section 11e may be longer than that of a third plate section 13e as an antenna element 10e shown in FIG. 14B.

### EXPLANATIONS OF MARKS

1 antenna apparatus

10 antenna element

11 first plate section

12 second plate section

13 third plate section

20 feeder

30 matching circuit

40 feeding point

50 ground plate

51 substrate

52 flexible substrate

1. An antenna apparatus, comprising:
an antenna element;
a feeder connected to the antenna element;
a matching circuit connected to the feeder;
a feeding point connected to the matching circuit; and
a ground plate, on which the feeding point and the matching circuit are mounted,
wherein the antenna element includes:
a first plate section connected to the feeder, the first plate section extending into a direction of going away from the ground plate in parallel with an extending direction of the ground plate;
a second plate section extending from an apical end of the first plate section almost perpendicularly; and
a third plate section extending from an apical end of the second plate section into a direction of coming closer to the ground plate in parallel with the first plate section;
wherein the ground plate can freely be folded up to the extending direction thereof; and
wherein when an interval of a gap from the ground plate to the antenna element, the interval formed by the feeder, is denoted by G, a length from the ground plate to an outer end portion of the second plate section is denoted by L, and a ratio of the interval G to the length L is denoted by R, the interval G, the length L, and the ratio R satisfy formulae (1)-(3),
G=R·L (1),
3.5 mm≦L≦11 mm (2), and
0.06≦R≦0.95 (3).

2. The antenna apparatus according to claim 1, wherein
when the ratio R is obtained in accordance with a formula (4), coefficients a1-a5 of the formula (4) satisfy following ranges, respectively,
R=a₁·L⁴+a₂·L³+a₃·L²+a₄·L+a₅ (4)
−0.0064≦a₁≦0.002204,
−0.07982≦a₂≦0.2316,
−3.1078≦a₃≦1.07710,
−6.4392≦a₄≦18.4168, and
−40.3927≦a₅≦14.5431.

3. The antenna apparatus according to claim 2, wherein the coefficients a1-a5 of the formula (4) satisfy following ranges, respectively, and the length L and the ratio R satisfy relations of formulae (5) and (6), respectively,
−0.0064≦a₁≦0.001554,
−0.05592≦a₂≦0.2316,
−3.1078≦a₃≦0.75217,
−4.5048≦a₄≦18,4168,
−40.3927≦a₅≦10.3087,
6.6 mm≦L≦11mm (5), and
0.08≦R≦0.61 (6).

4. The antenna apparatus according to claim 1, wherein an extending length of the first plate section is almost the same as and an extending length of the third plate section

5. The antenna apparatus according to claim 1, wherein a width of the antenna element is set to be almost the same as a width of the ground plate.

6. The antenna apparatus according to claim 1, wherein the ground plate is composed of two substrates in a state of being freely folded up, each being sized to have an extending length of 73 to 82 mm and a width of 35 to 45 mm.
